(19) United States
(12) Patent Application Publication
(10) Pub. No.: US 2012/0039668 A1
(43) Pub. Date: Feb. 16, 2012

(54) METHOD OF DETECTING GAS LEAKAGE IN GEOLOGICAL GAS RESERVOIR BY USING PRESSURE MONITORING AND GEOLOGICAL GAS STORAGE SYSTEM

(75) Inventors: Yong-Chan PARK, Daejeon (KR); Dae-Gee HUH, Daejeon (KR)

(73) Assignee: KOREA INSTITUTE OF GEOSCIENCE AND MINERAL RESOURCES(KIGAM), Daejeon (KR)

(21) Appl. No.: 13/198,907

(22) Filed: Aug. 5, 2011

(30) Foreign Application Priority Data
Aug. 10, 2010 (KR) 10-2010-0076979

(51) Int. Cl. B65G 5/00; G01M 3/02

(52) U.S. Cl. 405/53; 73/40

(57) ABSTRACT

A geological gas storage system and a method of detecting gas leakage from the geological gas storage system by using pressure monitoring, the geological gas storage system including: a formation structure including a reservoir formed of a permeable rock material in deep onshore/offshore formations, an impermeable cap rock layer formed above the reservoir, and an upper permeable formation formed of a permeable rock material above the cap rock layer; a hollow casing inserted in inner walls of the gas injection well bored from the ground to the reservoir and including a portion disposed at the same depth as a depth of the reservoir in which a plurality of gas injection holes are perforated in a circumferential direction of the casing; and a pressure sensor disposed at the same depth as a depth of the upper permeable formation and detecting pressure of the upper permeable formation. The method of detecting gas leakage from the geological gas storage system by using pressure monitoring includes detecting gas leakage from the reservoir by measuring a change in pressure of the upper permeable formation by using a pressure sensor installed at the upper permeable formation in the geological gas storage system having the above structure.

### CROSS-REFERENCE TO RELATED PATENT APPLICATION

This application claims the benefit of Korean Patent Application No. 10-2010-0076979, filed on Aug. 10, 2010, in the Korean Intellectual Property Office, the disclosure of which is incorporated herein in its entirety by reference.

### BACKGROUND OF THE INVENTION

1. Field of the Invention

The present invention relates to a geological gas storage system and a method of detecting gas leakage from the geological gas storage system, and more particularly, to a geological gas storage system in which carbon dioxide, natural gas or the like is stored using oil and gas reservoirs, saline aquifers or the like formed in deep onshore/offshore formations, and a method of detecting whether gas leaks from the geological gas storage system.

2. Description of the Related Art

Due to greenhouse gases steadily discharged after industrialization, a global warming problem draws great attention. For example, the height of a seal surface has increased by 10-25 cm for the past 100 years such South Pacific islands including Papua New Guinea have been submerged in the sea, iceberg in the northern hemisphere has decreased by about 20% or more and many problems such as desertification, an unusual change in the weather and the like occur.

There are various types of greenhouse gases that cause global warming, such as methane, Freon gas, carbon dioxide (CO₂), and the like. Among the greenhouse gases, CO₂ is controllable gas, and the ratio of CO₂ to the total quantity of the greenhouse gases is 80% and is the largest. Thus, a greenhouse gas problem is mainly focused on CO₂.

As one of technologies for reducing CO₂ mitigation, Carbon Capture and Storage (CCS) technology draws worldwide attention. In particular, International Energy Agency (IEA) estimated that 9.2 billion tons of CO₂, 19% of the total quantity of global CO₂ mitigation by 2050 should be taken care of by CCS technology. Global Carbon Capture and Storage Institute (GCCSI) and IEA forecast that more than 3,500 CCS projects will be needed by 2050 in order to accomplish this target. Only 4 geological storage projects of CO₂ worldwide, however, are currently running in a demonstration/commercial scale with more than 300 projects in a planning stage.

Geological storage concept is to store CO₂ captured in a power plant or the like in deep onshore/offshore formations semipermanently. The target formations are oil and gas reservoirs, saline aquifers and coal strata depending upon the geological environment. The most important factors in screening a geological storage site are good porosity and permeability of the formation with a depth of more than 800 m deep, presence of an impermeable cap rock above a reservoir rock (reservoir) to prevent the leakage of the injected CO₂.

In order to realize a geological storage technology, it is important to select an appropriate storage site and injection scheme to minimize the leakage of the injected CO₂. At the same time, monitoring & verification (MV) or monitoring, verification, and accounting (MVA) is also important which verifies that the injected CO₂ should be stored in the target formation and stay in the controlled location.

In the large scale geological storage projects such as Sleipner and Snohvit projects in Norway, Weyburn in Canada, In-Salah in Algeria, are running or planning. However, a reliable and cost effective monitoring method of verifying the leakage after injection of CO₂ has not been suggested, and furthermore, there is no internal monitoring protocol.

Because the purpose of the CCS is to obtain a carbon credit through geological storage, however, the MVA should be the first priority. In this context, a monitoring technology in the geological strata that has not been considered as being important in a conventional oil or natural gas development or oil recovery enhancement procedure has emerged as being important.

There are many monitoring methods such as geophysical monitoring, for example, seismic, electric, gravitational survey, pressure/temperature measurements in the formation, geochemical monitoring, for example, measurement of concentration of CO₂ on the surface of the earth or in the ground water, and borehole monitoring, etc. However, the reliability of a part of these monitoring technologies is lowered when they are separately applied, and even if all of available monitoring technologies are used, the tremendous amount of cost is required.

In addition, when the seismic method that is the most frequently applied method is used, in an onshore storage site, the environment and conditions of survey vary according to the effects of weather, season, and location of source/receiver, and thus, the reliability of the result of survey cannot be obtained. In an offshore site, we have another problem that no direct monitoring method is available due to a cost problem unlike the onshore site where observation well and aquifer, soil, and atmospheric monitoring methods can be used to detect the leakage of CO₂.

FIGS. 1 and 2 illustrate monitoring methods that are actually used in the Otway project of Australia. A wide range of monitoring program was applied in the Otway project. Referring to FIGS. 1 and 2, they applied atmospheric, soil and well logging methods as an assurance monitoring program to verify no leakage. Geophysical and geochemical methods were used to confirm the integrity of cap rock and storage.

In other words, the leakage of CO₂ was confirmed by measuring the concentration of CO₂ contained in the air or the aquifer in the vicinity of the storage and by measuring the concentration of CO₂ on the surface of the earth, or the leakage of CO₂ was investigated in a wide range by using a seismic survey or the like. Such a wide application of monitoring methods is possible because these monitoring methods are projects for research that have no relation with the cost, and when the monitoring methods are projects for an actual commercial use that require an astronomical cost, they cannot be widely applied.

A 4D seismic survey which is the combination of 3D seismic with the baseline measurement before the CO₂ injection was identified as a versatile method in the Sleipner project. It was verified that, when these methods were performed at the same time, reliable survey regarding detection of the leakage of CO₂ was possible. This 4D seismic is, however, relatively expensive and is not technically mature to quantify the CO₂ geological storage.

In particular, when the seismic method is used in offshore site, the interval of measurement can be as long as one year in case of the Sleipner project. As a result, leakage is not detected for a time period of one year. The seismic method also has a weakness of long processing time to analyze the results. FIG. 3 shows the time lapse 3D seismic survey in Sleipner project and illustrates the result of the seismic survey before CO₂ was injected in 1994 and the result of the seismic survey from 2001 after CO₂ was injected since 1996. Although it can be known from the result from 2001 that an area charged with CO₂ gradually and slightly increases, there is little difference in the plume shape of injected CO₂ according to an injection amount even one million tons of CO₂ per year was injected since 1996. In detail, it can be verified that it is difficult to quantify a change caused by an actual injection amount by using the seismic survey.

If the minimum injection rate of CO₂ is 3 million tons per year, the maximum quantity of leakage can be as large as 3 million tons before the next seismic survey is carried out when the 4D seismic survey is the only monitoring method. Any leakage of a large amount of CO₂ creates monitoring and an additional astronomical cost for remedy.

As a conclusion, a cost effective real time monitoring method is required because the current monitoring methods have difficulties to figure out the whole picture of CO₂ leakage. Thus, development of a technology that is cost effective and reliable and detects the leaking possibility of gas in real time is desperately needed.

### SUMMARY OF THE INVENTION

The present invention provides a cost effective method of detecting a leaking possibility of gas from storage in which carbon dioxide (CO₂), natural gas or the like is stored, with reliability in real time, and a geological gas storage system to which the method is applied.

According to an aspect of the present invention, a geological gas storage system includes: a formation structure including a reservoir formed of a permeable rock material in deep onshore/offshore formations, an impermeable cap rock layer formed above the reservoir, and an upper permeable formation formed of a permeable rock material above the cap rock layer; a hollow casing inserted in inner walls of the gas injection well bored from the ground to the reservoir and including a portion disposed at the same depth as a depth of the reservoir in which a plurality of gas injection holes are perforated in a circumferential direction of the casing; and a pressure sensor disposed at the same depth as a depth of the upper permeable formation and detecting pressure of the upper permeable formation.

The pressure sensor may be disposed at the same depth as a depth of the upper permeable formation through inner portions of the casing, and a plurality of observation holes may be perforated in a portion disposed at the same depth as a depth of the upper permeable formation in the circumferential direction of the casing so that the pressure sensor and the upper permeable formation communicate with each other.

In addition, an additional observation well may be perforated up to the upper permeable formation so that the pressure sensor is disposed at the same depth as a depth of the upper permeable formation through the observation well.

According to another aspect of the present invention, a method of detecting gas leakage in a geological gas reservoir by using pressure monitoring in the geological gas storage system includes detecting gas leakage from the reservoir by measuring a change in pressure of the upper permeable formation by using a pressure sensor installed at the upper permeable formation.

When pressure of the upper permeable formation increases within a predetermined time after gas is injected into the reservoir or when pressure of the upper permeable formation decreases within a predetermined time after injection of gas into the reservoir stopped, it may be determined that gas in the reservoir leaks upwards through outer walls of a casing of the gas injection well.

When pressure of the upper permeable formation increases after gas is injected into the reservoir or when pressure of the upper permeable formation decreases within a predetermined time after injection of gas into the reservoir stopped, a gas leaking area may be detected using a predetermined time from time when gas starts to be injected into the reservoir to time when pressure of the upper permeable formation is changed (increases or decreases).

When pressure of the upper permeable formation is changed out of a predetermined range while gas is injected into the reservoir, it may be determined that new cracks occurred in the cap rock layer.

A distance from the pressure sensor to the gas leaking area may be measured using a magnitude of the pressure change of the upper permeable formation.

### BRIEF DESCRIPTION OF THE DRAWINGS

The above and other features and advantages of the present invention will become more apparent by describing in detail exemplary embodiments thereof with reference to the attached drawings in which:

FIGS. 1 and 2 illustrate monitoring methods used in the Otway project of Australia;

FIG. 3 shows the time lapse 3D seismic survey in Sleipner project of Norway, and a left end of FIG. 3 illustrates the result of the seismic survey before CO₂ was injected, and a top side of FIG. 3 is a 2D cross section view of the seismic survey, and a bottom side of FIG. 3 is a plan view of the seismic survey;

FIG. 4 is a schematic diagram of a structure of a geological gas storage system according to an embodiment of the present invention;

FIG. 5 is a table showing basic conditions of 3D simulation for testing the effectiveness of a method of detecting gas leakage in a geological gas reservoir by using pressure monitoring, according to an embodiment of the present invention;

FIG. 6 illustrates a grid system and boundary conditions of 3D simulation based on the conditions of FIG. 5;

FIG. 7 is a graph showing a pressure change and a cumulative gas injection volume in a gas injection well according to elapsed time when gas was injected for 20 years and maintained for 100 years in 3D simulation in case of no leaking;

FIG. 8 is a graph showing a pressure change in a gas injection well according to elapsed time in 3D simulation indicating three cases, i.e., in case of no leaking (case 1), in case of leaking of CO₂ through outer walls of a casing (case 2), and in case of leaking of CO₂ through cracks in a cap rock layer or a single layer (case 3);

FIG. 9 is a graph showing a pressure change in a gas injection well and an upper permeable formation according to elapsed time in 3D simulation in case of no leaking (case 1);

FIG. 10 is a graph showing a pressure change in a gas injection well and an upper permeable formation according to elapsed time in 3D simulation in case of leaking of CO₂ through outer walls of a casing (case 2);

FIG. 11 shows the location of cracks occurred in a cap rock layer and the vertical permeability distribution in 3D simulation of case 3;

FIG. 12 is a graph showing a pressure change in a gas injection well and an upper permeable formation according to elapsed time in 3D simulation in case of leaking of CO₂ through cracks of a cap rock layer (case 3);

FIG. 13 is a graph showing a pressure change in an upper permeable formation according to elapsed time in 3D simulation indicating three cases, i.e., in case of no leaking (case 1), in case of leaking of CO₂ through outer walls of a casing (case 2), and in case of leaking of CO₂ through cracks in a cap rock layer (case 3); and

FIG. 14 is a graph showing the relationship between a distance difference in leaking points and time when a pressure change occurs; and

FIG. 15 is a schematic diagram of a structure of a geological gas storage system according to another embodiment of the present invention.

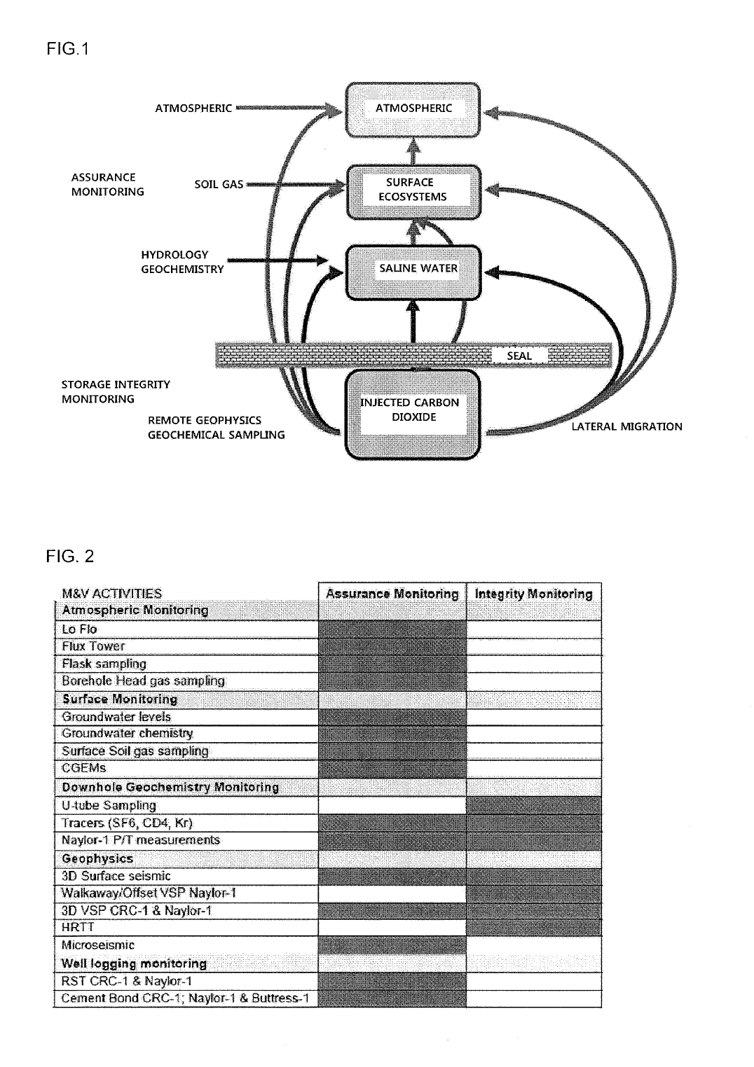

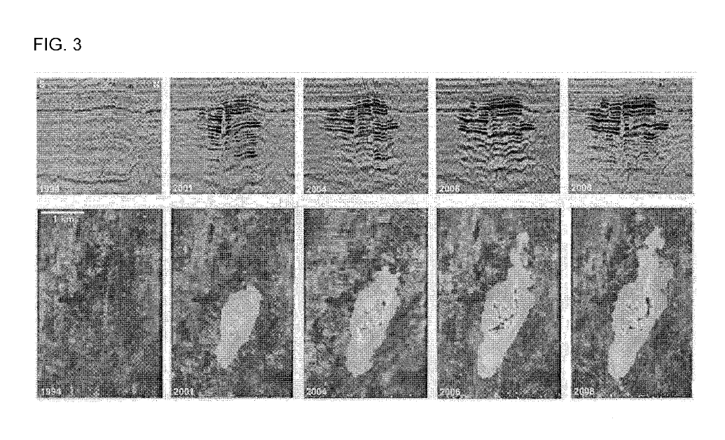

### DETAILED DESCRIPTION OF THE INVENTION

Hereinafter, a geological gas storage system and a method of detecting gas leakage in a geological gas reservoir by using pressure monitoring according to exemplary embodiments of the present invention will be described with reference to the accompanying drawings, in which the exemplary embodiments of the present invention are shown.

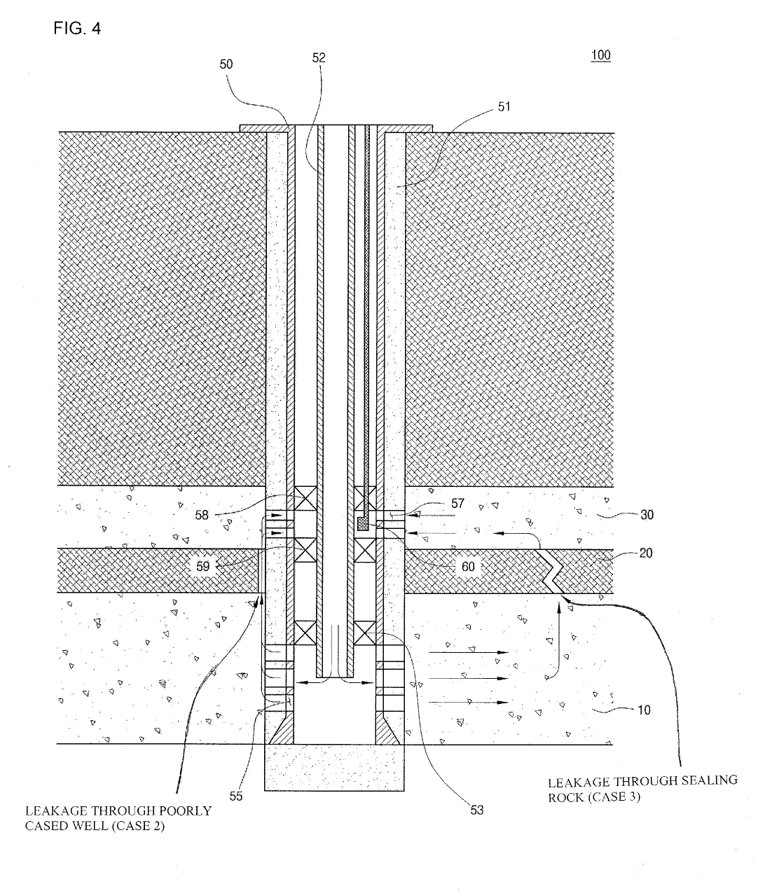

FIG. 4 is a schematic diagram of a structure of a geological gas storage system 100 according to an embodiment of the present invention.

Referring to FIG. 4, the geological gas storage system 100 according to the current embodiment of the present invention basically stores gas such as carbon dioxide (CO₂) or the like in deep offshore/onshore formations, and a specific geological structure is required to store gas.

In other words, a reservoir 10 and a cap rock layer 20 are needed to store gas. Gas is injected into and stored in the reservoir 10, and the reservoir 10 is to be formed of a rock material having porosity and permeability, such as sedimentary rock including sand, sandstone, arkose sandstone or the like. Reservoir rock in which oil or natural gas is embedded, has the same conditions as those of the reservoir 10. Thus, an oil or gas reservoir whose development has been completed is used as the reservoir 10. An aquifer in which underground water is saturated in pores of rock, is also used as the reservoir 10.

The principle of gas storage will now be described in more detail. Fine pores in the reservoir 10 formed of a porous rock material are saturated with hydrocarbon such as oil or natural gas or a fluid such as water, and gas such as CO₂ is injected into the reservoir 10 with high pressure in such a way that gas pulls out the fluid in the pores and is charged and stored in the pores of the reservoir 10. In addition, the reservoir 10 is required to have a depth of about 800 m deep in deep formations so as to inject and store gas with high pressure.

In order to prevent leakage of gas stored in the reservoir 10 through the reservoir 10, the cap rock layer 20 formed of an impermeable rock material (with very low porosity and permeability) needs to exist above the reservoir 10 like in the oil or gas reservoir. The cap rock layer 20 such as the oil or gas reservoir is generally formed as a shale layer.

As described above, the permeable reservoir 10 needs to exist, and the impermeable cap rock layer 20 needs to exist above the reservoir 10 so as to store gas. However, the main purpose of the present invention is to verify whether gas injected into the reservoir 10 leaks through cracks in the cap rock layer 20 or outer walls of a casing 50 of a gas injection well w upwards. Thus, an additional formation structure is required. In other words, an upper permeable formation 30 formed of a rock material having porosity and permeability, such as sandstone, has to exist above the cap rock layer 20.

Specifically, when cracks occur in the cap rock layer 20 or a gap is formed between the outer walls of the casing 50 of the gas injection well w that will be described below and the cap rock layer 20, injected gas leaks from the upper permeable formation 30 through the cracks or gap, or the injected gas pulls out a fluid that exists in the upper permeable formation and causes a change of pressure of the upper permeable formation 30.

The technical idea of the present invention is to detect a possibility of gas leakage from the reservoir 10 to the upper permeable formation 30 by measuring pressure of the upper permeable formation 30.

The gas injection well w for injecting gas is formed on the conditions of the geological structure described above. The gas injection well w is formed by boring from the ground to the reservoir 10. The casing 50 is inserted in the gas injection well w. After the casing 50 is inserted in the gas injection well w in a hollow and tubular shape, a sealing material 51, such as mortar, is deposited between the outer walls of the casing 50 and inner walls of the gas injection well w, thereby fully sealing a space between the reservoir 10 and the cap rock layer 20 and a space between the cap rock layer 20 and the upper permeable formation 30. Since a bore hole has already been formed in the oil or gas reservoir whose development has been completed, the bore hole may be reused as the gas injection well w.

Tubing 52 for guiding gas, such as CO₂, is disposed in the gas injection well w. The tubing 52 is inserted in the gas injection well w from the ground, and a bottom end portion of the tubing 52 is disposed at a depth of the reservoir 10. A plurality of gas injection holes 55 are formed in a bottom end portion of the casing 50 in a circumferential direction of the casing 50. High-pressure gas discharged from the tubing 52 is injected into the reservoir 10 through the gas injection hole 55 formed through the casing 50 and the sealing material 51.

A packer 53 is inserted between the bottom end portion of the tubing 52 and the casing 50 so that an area of the bottom end portion of the casing 50 into which gas is injected and an upper area above the area are isolated from each other and are sealed.

A plurality of observation holes 57 are perforated in an area of the entire area of the casing 50 that is disposed at the same depth as that of the upper permeable formation 30 in the circumferential direction of the casing 50. The observation holes 57 are formed through the casing 50 and the sealing material 51 so that the upper permeable formation 30 and an inside of the casing 50 communicate with each other. Ring-shaped packers 58 and 59 are inserted between inner walls of the casing 50 and an outer surface of the tubing 52 above and below each observation hole 57 so that inner portions of the casing 50 in which the observation holes 57 are formed, are isolated from each other and are sealed. The sealed area is disposed in a range of a depth of the upper permeable formation 30.

A pressure sensor 60 is disposed in the area sealed by the packers 58 and 59. The pressure sensor 60 is installed to contact a controller on the ground in a wired or wireless manner. The pressure sensor 60 detects pressure of the upper permeable formation 30 transferred through the observation holes 57. In other words, since a space in which the pressure sensor 60 is disposed, is sealed by the packers 58 and 59 and communicates with only the upper permeable formation 30 through the observation holes 57, the pressure sensor 60 may detect a pressure change in the upper permeable formation 30.

When gas leaking from the reservoir 10 flows into pores (filled with water or a fluid) of the upper permeable formation 30 via the cap rock layer 20, pressure caused by the inflow of gas is transferred to the entire upper permeable formation 30 via a medium in the pores. The pressure sensor 60 detects the pressure change in the upper permeable formation 30, and thus gas leaks from the reservoir 10.

In particular, reservoir pressure has a characteristic of fast propagation through the entire upper permeable formation 30 without actual movement of reservoir fluids (injected gas or a fluid such as hydrocarbon or water saturated in the pores) to a specified location. In detail, pressure caused by gas leakage is continuously propagated to the medium (existing fluid charged in the upper permeable formation 30) charged in the pores of the upper permeable formation 30, thereby inferring gas leakage. The pressure change in the upper permeable formation 30 caused by the inflow of the fluid may be detected nearly and immediately compared to an actual migration time of the fluid, thereby functioning as a gas leakage monitoring unit with high quality.

An example of a method of detecting gas leakage in a geological gas reservoir by using the geological gas storage system 100 and pressure monitoring, according to the present invention will now be described.

First, a gas leaking area can be estimated through the correlation between a location of gas leakage and the pressure change in the upper permeable formation 30. In other words, when the gas leaking area is close to the pressure sensor 60, a pressure transferring time is shorter than a pressure transferring time when the gas leaking area is far from the pressure sensor 60. Reversely, when the gas leaking area is far from the pressure sensor 60, the pressure transferring time is relatively longer.

In this regard, in the present invention, time from when gas is injected into the reservoir 10 to time when pressure of the upper permeable formation 30 increases, is measured, thereby reversely estimating a distance at which leakage occurred, by using the measured time. The gas leaking area may be estimated along a concentric circle based on approximately the pressure sensor 60.

In particular, leaking through the outer walls of the casing 50 occurs in the geological gas storage system 100 easily. In this regard, although leaking through the outer walls of the casing 50 generally means leaking between outer walls of the sealing material 51 and an inside of the gas injection well w, leaking through the outer walls of the casing 50 may include a case of leaking from a storage site at the upper permeable formation 30 through cracks in a space between the outer walls of the casing 50 and an inside of the sealing material 51 and cracks in the sealing material 52 and a case of leaking from a storage site at the upper permeable formation 30 through cracks in both the casing 50 and the sealing material 52.

As illustrated in FIG. 4, when there is leaking through the outer walls of the casing 50, a leaking area is the closest to the pressure sensor 60 and thus, pressure of the upper permeable formation 30 increases nearly immediately. Thus, in the present invention, when the pressure of the upper permeable formation 30 increases within a predetermined time from time when gas is injected into the reservoir 10, leaking through the outer walls of the casing 50 occurs.

The leaking area is generally predicted from a gas injection time to time when the pressure of the upper permeable formation 30 increases. There are many variables in quantifying the correlation between a distance and a pressure change time. The pressure change time may vary depending upon porosity and permeability of the upper permeable formation 30, boundary conditions of the reservoir 10 and the upper permeable formation 30, a gas injection pressure, or the like.

If a predetermined time elapsed after gas starts to be injected, a normal state with no pressure change according to elapsed time is maintained. In detail, although there is leaking, when the pressure of the upper permeable formation 30 increases at the time when gas starts to be injected, the upper permeable formation 30 is maintained at a constant level without any pressure change according to elapsed time.

When the normal state is maintained and the pressure of the upper permeable formation 30 increases suddenly, it may be deemed that new leaking occurs. Releasing of the normal state may be regarded that new cracks occurred in the cap rock layer 20 or leaking occurred in the outer walls of the casing 50 so that the fluid in the reservoir flows into the upper permeable formation 30.

Even when the normal state is maintained after gas injection starts, there may be a pressure change in a predetermined range. Thus, in the present invention, it is deemed that the pressure change in a predetermined range is neglected and new cracks occurred only when the pressure of the upper permeable formation 30 increases out of a predetermined range.

In addition, when injection into the reservoir 10 stopped, the normal state is released, and inflow of the fluid into the upper permeable formation 30 is reduced. Thus, a leaking area may be estimated using the correlation between time when gas injection stopped to time when the pressure of the upper permeable formation 30 decreases.

Even in this case, like in case of gas injection, when a pressure decrease of the upper permeable formation 30 from the time when gas injection stopped occurs within a predetermined time, it may be regarded that leaking occurs in the outer walls of the casing 50. Since time when the pressure decrease is detected and a distance from the pressure sensor 60 to a gas leaking point is generally in proportion to each other, the leaking area may be predicted along a concentric circle based on approximately the pressure sensor 60 as time elapsed.

The gas leaking area may also be predicted using the magnitude of the pressure change as well as time when the pressure change is detected. In other words, regardless of gas injected with the same pressure, when the gas leaking area is close to the pressure sensor 60, the pressure change of the upper permeable formation 30 is relatively larger than a case where the gas leaking area is far from the pressure sensor 60. Since pressure is transferred in all directions, when pressure is transferred from a long distance, a loss of pressure increases compared to a case where the gas leaking area is far from the pressure sensor 60, and the loss of pressure occurs due to the effects of peripheral conditions on the transfer path.

In the present invention, as described above, the gas leaking point may be predicted and determined using the time when the pressure change is detected from the upper permeable formation 30 and the magnitude of the pressure change. The location and distance of the gas leaking point may be precisely determined in a quantitative manner only when the peripheral conditions are considered. However, the base of quantitative measurement can be established according to the present invention.

In the present invention, gas leaks through the outer walls of the casing 50 or through cracks in the cap rock layer 20 or the single layer. Here, gas leakage means that gas injected for storage leaks directly from a storage site at the upper permeable formation 30 via the cap rock layer 20 from the reservoir 10 and since a predetermined time period is required that the injected gas reaches an area where cracks occurred, an existing fluid such as natural gas, oil, and a fluid such as water filled in the pores of the reservoir 10 leaks from a storage site at the upper permeable formation 30 via the cap rock layer 20.

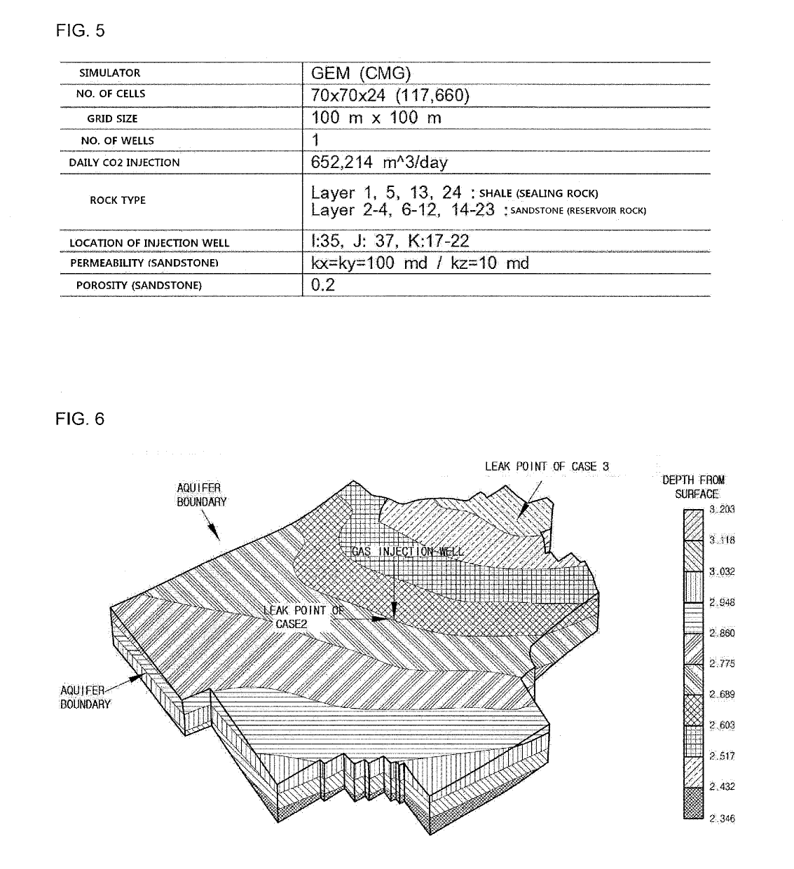

The validity of the present invention was verified through a reservoir simulation. In CO₂ isolation simulation, a reservoir simulator GEM was used which is a multi-component compositional model developed by Computer Modeling Group (CMG) of Canada. Input data and a grid system of a saline aquifer system is shown in Table of FIG. 5. The basic geometry is the same as that of a reservoir (Lee, J. H., Park, Y. C., Sung, W. M. and Lee, Y. S. (2010) ‘A Simulation of a Trap Mechanism for the Sequestration of CO2 into Gorae V Aquifer, Korea’, Energy Sources, Part A: Recovery, Utilization, and Environmental Effects, 32: 9, pp 796-808) reported by Lee et. al. (2010); 70×70×24 grids with total 117,660 cells and one injection well. The target of Lee's study is an actual reservoir, however, since the reservoir has characteristics that are not good for CO₂ storage, the porosity and the permeability of target strata were 20% and 100 md, respectively. The vertical permeability which determines the leakage of CO₂ injected is 10 millidarcy (md) which is 1/10 of the horizontal permeability. The hysteresis of relative permeability was neglected.

FIG. 6 shows the grid system used in this simulation, and numbers in FIG. 6 indicate a top depth (depth from the surface of the earth) of each cell. For boundary conditions, the right hand side of the model is closed to the faults so that CO2 injected into a single layer formed at a bottom end portion and a right side of an aquifer is prevented from leaking in a direction of the single layer, while the left hand side of the model is open to the saline aquifer.

Three basic scenarios are performed to study the effectiveness of pressure monitoring method. Case 1, the baseline case (standard) is the case of no leakage from the CO₂ storage reservoir. Pressure in a gas injection well and an injection rate in case 1 are determined, and pressure in an upper permeable formation is observed.

Case 2 is the case of leaking of CO₂ through the casing of the injection well which is the shortest leaking channel. In case 2, cell (35, 37, 13) of a cap rock layer is assumed to be permeable.

Case 3 is the leaking case of CO₂ through the cracks of faults far from the injection well. In detail, as shown in FIG. 6, CO₂ leakage takes place in the cell (35, 69, 13) of the top cap rock which is 3.2 km away in the horizontal direction and 391 m away from the vertical direction. The distance between the pressure measuring point and the CO₂ injection point is only 50 m in case 2 while it is more than 6 km in case 3.

It is assumed that the total quantity of CO₂ injection is 9 million tons for 20 years which is equivalent to 1,233 tons/day or 652,214 m³/day. This injection amount is relatively small considering that a typical coal fired power plant of 500 MW emits about 300 million tons of CO₂ per year. But we try to minimize the quantity of CO₂ injection as low as possible because our goal is to detect the CO₂ leakage from a small storage site at the upper formation with pressure monitoring. Even when a small amount of gas is injected, whether a pressure change can be detected needs to be regarded.

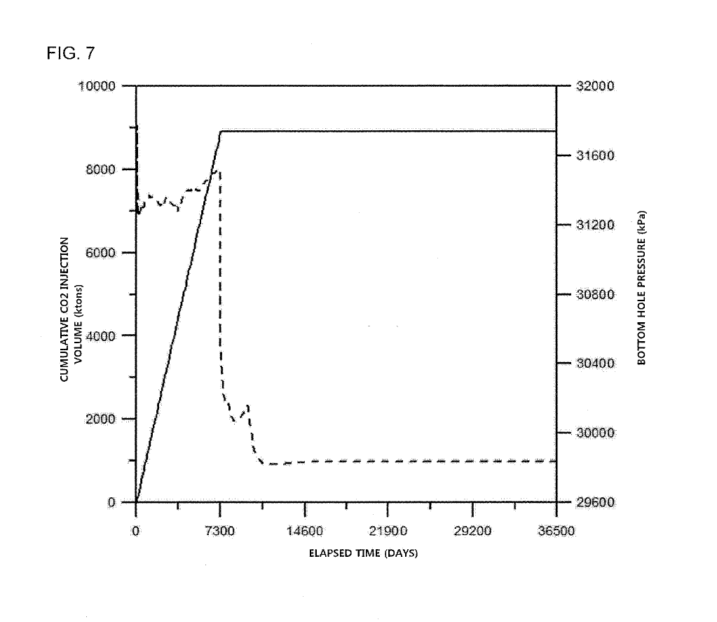

FIG. 7 shows a bottom hole pressure (BHP) and a cumulative injection volume of the injection well in case 1.

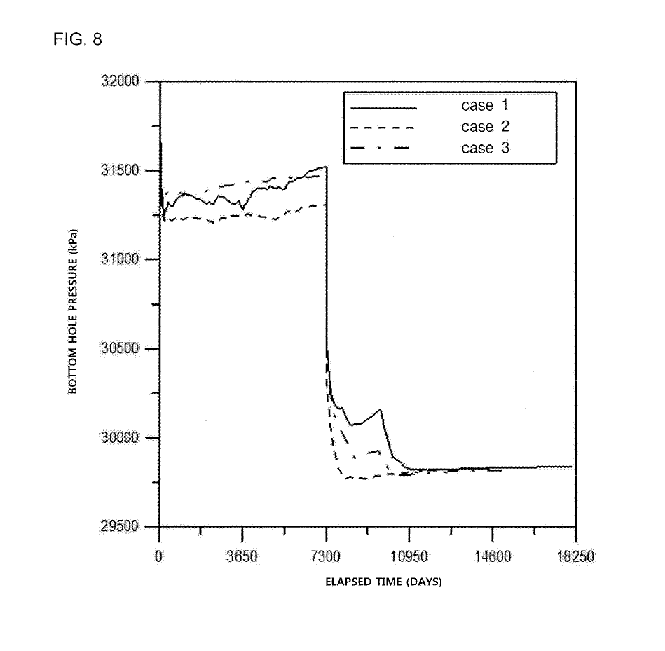

The BHP of the injection well for three cases was shown in FIG. 8. The case 1, which is no leaking case, maintained the BHP highest. The BHP in case 1, leaking through the casing, was the lowest. The BHP in case 3 was in between. The reason of this pressure behavior is that the distance between the monitoring point and the leaking point in case 3 is longer than that of case 2. When the leaking takes place in case 2, the leaking path is only 50 m directly to the top of the formation, while the fracture on the cap rock is about 6 km far from the injection well in case 3.

Since there are hardly reference data about a quantitative leaking amount of CO₂ through the casing or cracks, the vertical permeability of the cell in which the leaking of CO₂ occurs was assumed 10 and without any knowledge about the amount of CO₂ leakage through cracks or casing from the storage.

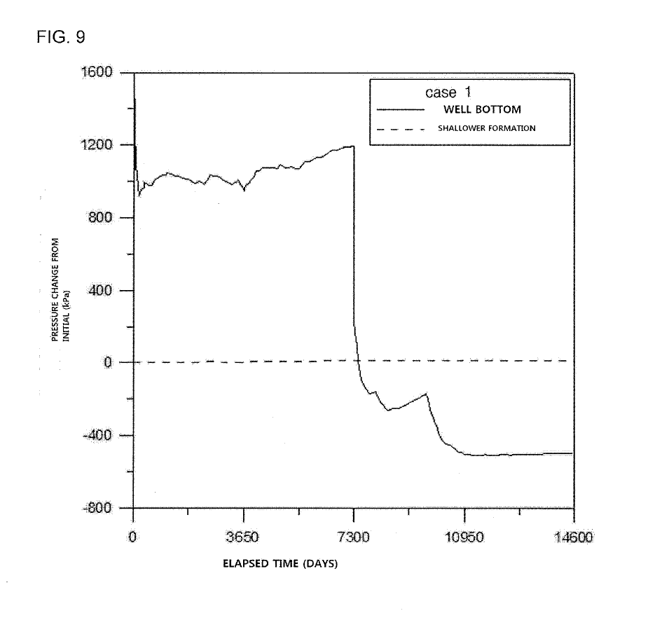

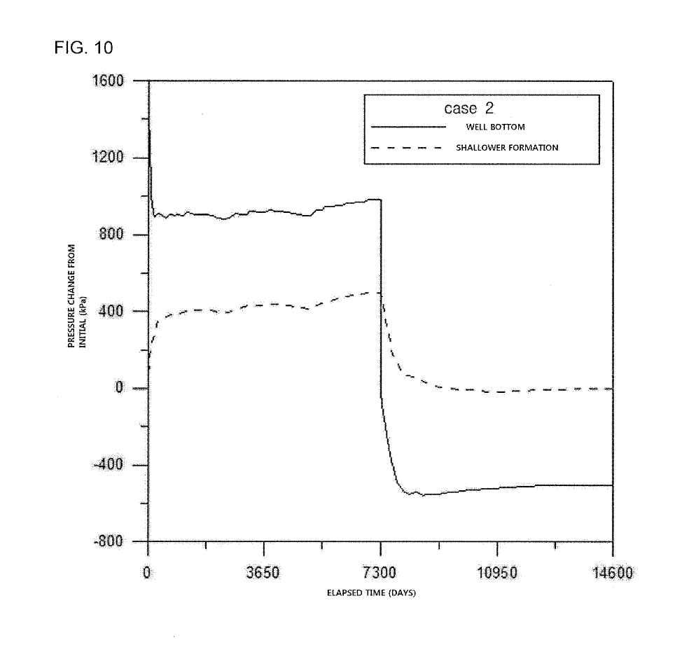

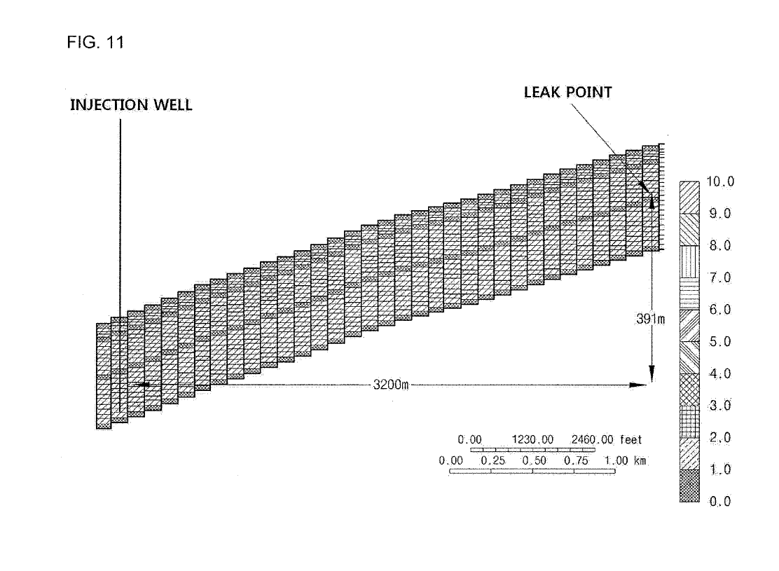

FIGS. 9 and 10 indicate pressure profiles both at the injection well and the monitoring location for case 1 and case 2, respectively.

The pressure profile at the monitoring location exhibits no change in case 1. Case 2, however, shows a considerable pressure change with CO₂ injection. As shown in FIG. 10, the maximum pressure change in the injection well is about 981.2 kPa at the time of 7300 days after injection which corresponds to the end of injection period of CO₂. At this time, the pressure change at the monitoring location of the upper formation is about 495.3 kPa almost half of the pressure change at the injection well.

In the above simulation results, there is a remarkable pressure difference at the upper permeable formation in cases of leaking and no leaking. This may prove that pressure measurement at the upper permeable formation contributes to leaking detection or a leaking indicator.

This pressure response enables us to detect the CO₂ leakage by monitoring the pressure of the upper formation. One interesting thing is that the actual arrival of the leaked CO₂ through the casing to the upper formation takes 40 days. The leaking can be easily detected because the pressure response is almost instantaneous with CO₂ injection.

Case 3 is the case of leaking through potential cracks in cap rock far from the injection point, as described above. As shown in FIG. 11, the leaking point is 3,200 m apart in horizontal direction and 391 m apart in vertical direction from the injection point. Also, FIG. 11 indicates the vertical permeability of a bottom hole, a cap rock layer, and the upper permeable formation, respectively. The cap rock layer has the permeability of 0, and the bottom hole and the upper permeable formation have very high permeability. This shows that the permeability of the cap rock layer is changed and cracks occurred in a leaking area.

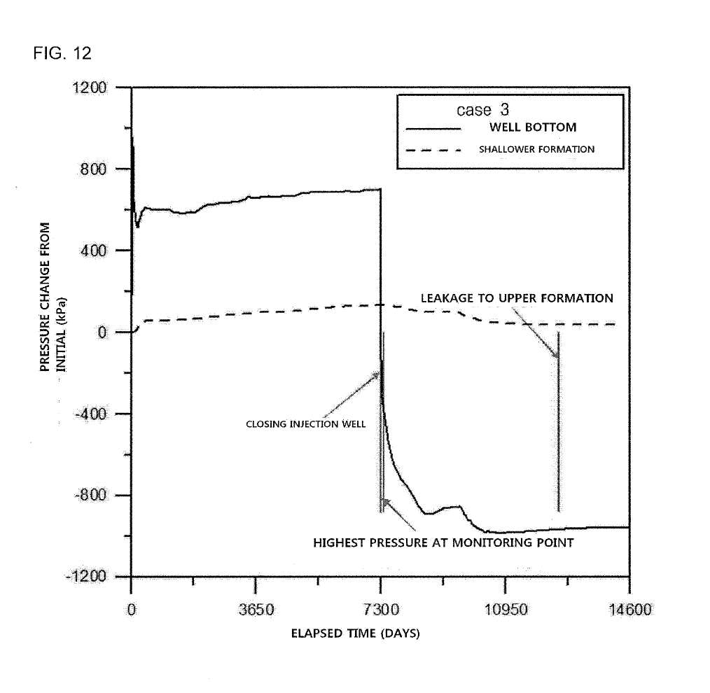

The results shown in FIG. 12 indicate that the maximum pressure change in the injection well is about 699.2 kPa which is higher than case 2, but lower than case 1. The maximum pressure change in the upper formation is 130.6 kPa which is lower than case 2.

In addition, referring to FIG. 12, although the actual arrival of leaked CO₂ at the upper permeable formation in case 3 is about 34 years later when 12,400 days elapsed after the CO₂ injection, the pressure response occurred already. This means that it is very convenient to detect the CO₂ leakage by monitoring the pressure response in the upper formation of the CO₂ storage reservoir. The maximum pressure response occurred 7300 days after the CO₂ injection when the CO₂ injection stopped.

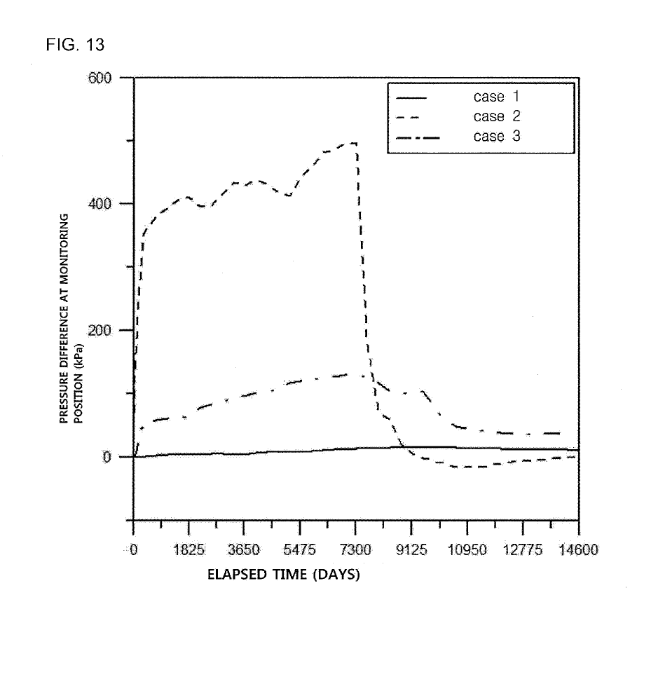

As illustrated in FIG. 13, if we plot the pressure profiles at the upper formation in case 1, case 2, and case 3, it is obvious to recognize the applicability of the proposed technique. Although the pressure response varies with the distance between the monitoring point and the leaking point, we can easily detect the leaking possibility from the pressure response at the upper formation and prevent the CO₂ leakage in advance.

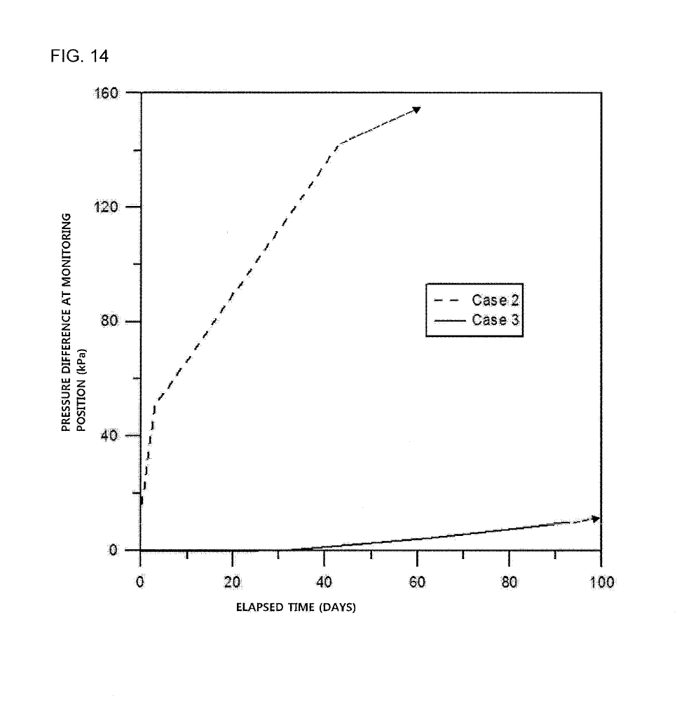

In addition, the leaking path in case 3 is about 3 km far from the injection well compared to case 2. FIG. 14 shows that the distance difference affects the arrival time as well as the magnitude of the pressure change. Referring to FIG. 14, in case of leaking through the casing of the injection well, a very quick pressure increase was verified after injection, and in case of long-distance leaking in case 3, the response time is delayed in case 3 compared to case 2. In detail, it was verified that there is currently a limitation in quantitative location detection and schematic leaking location detection or qualitative location estimation can be performed by utilizing history matching etc.

As verified in the simulation results, whether gas leaks from the bottom hole in the geological gas storage system can be detected using a pressure change of the upper permeable formation disposed above the cap rock layer.

In other words, by using the method according to the present invention, gas leakage can be directly detected, and the pressure sensor 60 measures and transmits pressure values in real time, thereby enabling an immediate pressure response when gas leakage is detected.

Furthermore, an area in which gas leakage occurs, can be estimated by using a time interval at which a pressure change occurs in the upper permeable formation from time of gas injection or time of stopping gas injection or by using the magnitude of a pressure change in the upper permeable formation.

In other words, the present invention has a huge significance that the base of detecting whether gas is in a controllable location and leaks outwards in a cost effective and reliable manner has been established and a real time response to gas leakage can be performed.

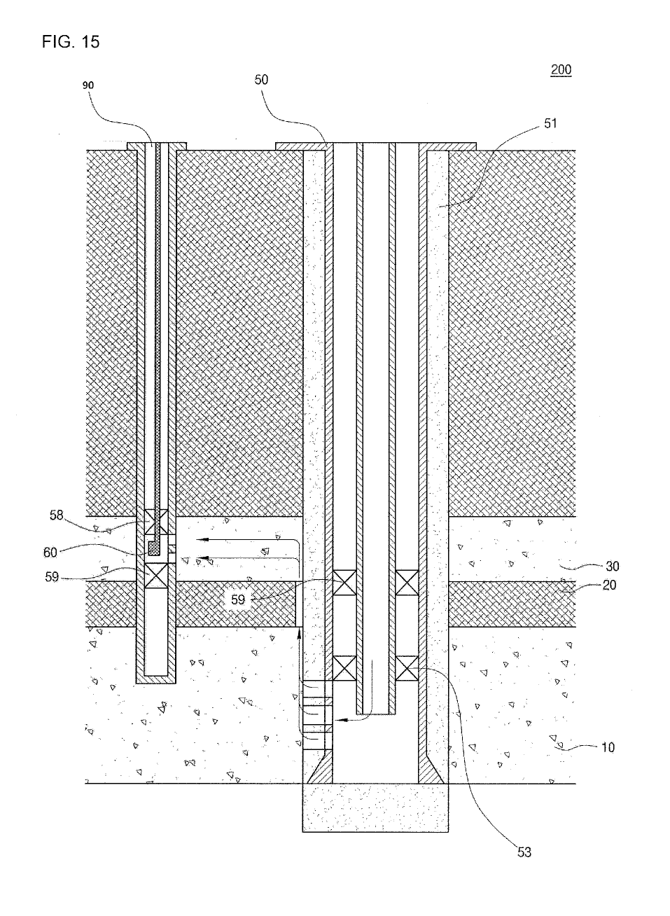

As described above, the pressure sensor 60 is installed with installation of the injection well, however, the present invention is not limited thereto. As illustrated in an embodiment 200 of FIG. 15, a pressure change in the upper permeable formation can also be measured by installing an observation well 90 that is separate from the injection well. Other elements of the embodiment 200 of FIG. 15 except that the additional observation well 90 is bored separate from the injection well and the pressure sensor 60 is installed at the observation well 90, are the same as those of the embodiment of FIG. 4 described above, and thus, a detailed description thereof will not be provided here.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of detecting gas leakage in a geological gas reservoir by using pressure monitoring in a geological gas storage system for injecting and storing gas in a reservoir through a gas injection well by boring the gas injection well from the ground to the reservoir, the geological gas storage system having a formation structure comprising a reservoir formed of a permeable rock material in deep onshore/offshore formations, an impermeable cap rock layer formed above the reservoir, and an upper permeable formation formed of a permeable rock material above the cap rock layer, whereby whether gas leaks from the reservoir of a geological gas storage system is detected, the method comprising detecting gas leakage from the reservoir by measuring a change in pressure of the upper permeable formation by using a pressure sensor installed at the upper permeable formation.

2. The method of claim 1, wherein a pressure sensor for measuring pressure of the upper permeable formation is installed in the gas injection well at the same depth as a depth of the upper permeable formation, and upper and lower sides of an area of the gas injection well in which the pressure sensor is installed, are sealed so that the pressure sensor communicates with only the upper permeable formation and measures a pressure change of the upper permeable formation.

3. The method of claim 1, wherein the pressure sensor is installed by perforating an observation well that is separate from the gas injection well from the ground to the upper permeable formation, thereby measuring a pressure change of the upper permeable formation.

4. The method of claim 1, wherein, when pressure of the upper permeable formation increases within a predetermined time after gas is injected into the reservoir, it is determined that gas in the reservoir leaks upwards through outer walls of a casing of the gas injection well.

5. The method of claim 1, wherein, when pressure of the upper permeable formation increases after gas is injected into the reservoir, a gas leaking area is detected using a time from time when gas starts to be injected into the reservoir to time when pressure of the upper permeable formation increases.

6. The method of claim 1, wherein, when pressure of the upper permeable formation is changed out of a predetermined range while gas is injected into the reservoir, it is determined that new cracks occurred in the cap rock layer.

7. The method of claim 1, wherein, when pressure of the upper permeable formation decreases within a predetermined time after injection of gas into the reservoir stopped, it is determined that gas in the reservoir leaks upwards through the outer walls of the casing of the gas injection well.

8. The method of claim 1, wherein, when pressure of the upper permeable formation decreases after injection of gas into the reservoir stopped, a gas leaking area is detected using a time from time when injection of gas into the reservoir stopped to time when pressure of the upper permeable formation decreases.

9. The method of claim 1, wherein a distance from the pressure sensor to the gas leaking area is measured using a magnitude of the pressure change of the upper permeable formation.

10. A geological gas storage system comprising:
a formation structure comprising a reservoir formed of a permeable rock material in deep onshore/offshore formations, an impermeable cap rock layer formed above the reservoir, and an upper permeable formation formed of a permeable rock material above the cap rock layer;
a hollow casing inserted in inner walls of the gas injection well bored from the ground to the reservoir and comprising a portion disposed at the same depth as a depth of the reservoir in which a plurality of gas injection holes are perforated in a circumferential direction of the casing; and
a pressure sensor disposed at the same depth as a depth of the upper permeable formation and detecting pressure of the upper permeable formation.

11. The system of claim 10, wherein the pressure sensor is disposed at the same depth as a depth of the upper permeable formation through inner portions of the casing, and a plurality of observation holes are perforated in a portion disposed at the same depth as a depth of the upper permeable formation in the circumferential direction of the casing so that the pressure sensor and the upper permeable formation communicate with each other.
